(19) United States
(12) Patent Application Publication
(10) Pub. No.: US 2026/0124741 A1
(43) Pub. Date: May 7, 2026

(54) Industrial Robot Comprising Adapter for Mounting, and System

(71) Applicant: ABB Schweiz AG, Baden (CH)

(72) Inventors: Tomas Botold, Västerås (SE); Jiangwei Huang, Västerås (SE)

(73) Assignee: ABB Schweiz AG, Baden (CH)

(21) Appl. No.: 19/438,989

(22) Filed: Jan. 2, 2026

Related U.S. Application Data
(63) Continuation of application No. PCT/EP2023/069481, filed on Jul. 13, 2023.

(51) Int. Cl. B25J 9/00

(52) U.S. Cl. CPC B25J 9/0009

(57) ABSTRACT

An industrial robot comprising a base member including a base interface and a plurality of base holes for receiving bolts passing through a support structure in a first direction to secure the base member such that the base interface mates with the support structure; and an adapter for optional use to change a manner of mounting the industrial robot, the adapter including a first adapter interface, a second adapter interface, a plurality of first through holes for receiving bolts to secure the adapter to the base member such that the first adapter interface mates with the base interface, and a plurality of second through holes for receiving bolts passing therethrough and into the support structure in a second direction, opposite to the first direction, to secure the adapter such that the second adapter interface mates with the support structure.

### CROSS-REFERENCE TO RELATED APPLICATIONS

The instant application claims priority to International Patent Application No. PCT/EP2023/069481, filed Jul. 13, 2023, which is incorporated herein in its entirety by reference.

### FIELD OF THE DISCLOSURE

The present disclosure generally relates to industrial robots and, more particularly, to an adapter for use to change a manner of mounting the industrial robot to a support structure.

### BACKGROUND OF THE INVENTION

In some processing environments, it is desirable to maintain a high level of hygiene. Examples of such processing environments include environments where food, beverages or pharmaceuticals are handled by an industrial robot. Any sanitary problems in such processing environment might result in severe consequences. For this reason, comprehensive cleaning of the robot and its surroundings is often performed daily. Typical cleaning procedures include high pressure washing with hot water containing chemical agents, such as strong acidic or alkaline detergents and disinfectants.

To improve the hygienic design of an industrial robot, the robot may be mounted bottom up to a support structure, such as a floor, a wall or a ceiling. With a bottom-up mounting it is meant that a plurality of bolts is passed from an outside of the support structure, through the support structure and into a base member of the robot on an inside of the support structure. With such mounting, the support structure can be positioned between the heads of the bolts and the base member. In this way, the bolts are not visible from the inside of the support structure and do therefore also not interrupt any smooth surfaces of the robot.

In some applications, bottom-up mounting may not be easily available. The outside of the support structure may for example be difficult or impossible to access. One way to overcome this problem is to reconstruct the support structure to enable bottom-up mounting. This solution is, however, very costly and time-consuming. A further way to overcome this problem is to offer for sale two different variants of base members for the industrial robot, i.e., one base member dedicated to bottom-up mounting and a different base member dedicated to top-down mounting. This solution, however, requires different types of base members to be held in stock and does not enable the robot to be remounted in a different way, i.e., changed from top-down mounting to bottom-up mounting, or vice versa.

U.S. Pat. No. 5,513,946 A discloses a robot comprising a substantially cylindrical robot base having a flange at the lower end portion of its outer circumferential surface. The flange is fixed on a floor of a factory or a platform on the floor by bolts or the like.

### BRIEF SUMMARY OF THE INVENTION

The present disclosure generally describes an improved industrial robot.

In an embodiment describes an industrial robot comprising an adapter that can be used in situations where bottom up mounting of a base member to a support structure is not available. The base member can be mounted top down to the support structure using the adapter without having to provide different designs of the base member and while still providing a good hygienic design of the industrial robot.

According to a first aspect, there is provided an industrial robot comprising a base member including a base interface and a plurality of base holes for receiving bolts passing through a support structure in a first direction to secure the base member to the support structure such that the base interface mates with the support structure. The industrial robot further comprises an adapter for optional use to change a manner of mounting the industrial robot to the support structure, the adapter including a first adapter interface, a second adapter interface, a plurality of first through holes for receiving bolts to secure the adapter to the base member such that the first adapter interface mates with the base interface, and a plurality of second through holes for receiving bolts passing therethrough and into the support structure in a second direction, opposite to the first direction, to secure the adapter to the support structure such that the second adapter interface mates with the support structure.

The industrial robot can thus be mounted to the support structure in a first manner where the base interface mates with the support structure, and in a second manner where the first adapter interface mates with the base interface and the second adapter interface mates with the support structure. The first manner and the second manner are herein referred to as bottom-up mounting and top-down mounting, respectively. The first direction and the second direction may be a distal direction and a proximal direction, respectively, of the industrial robot.

### BRIEF DESCRIPTION OF THE SEVERAL VIEWS OF THE DRAWING(S)

FIG. 1 is a schematic perspective view of a system comprising an industrial robot including a base member and an adapter in accordance with the disclosure.

FIG. 2 is a schematic perspective view of the adapter in accordance with the disclosure.

FIG. 3 is an end view of the industrial robot and the base member thereof in accordance with the disclosure.

FIG. 4 is a cross-sectional side view of the base member along line A-A in FIG. 3 when mounted to a support structure in a first manner without the adapter in accordance with the disclosure.

FIG. 5 is an end view of the industrial robot and of the base member and the adapter thereof in accordance with the disclosure.

FIG. 6 is a cross-sectional side view of the adapter along line B-B in FIG. 5 in accordance with the disclosure.

FIG. 7 is a cross-sectional side view of the base member and the adapter along line C-C in FIG. 5 when mounted to the support structure in a second manner with the adapter in accordance with the disclosure.

### DETAILED DESCRIPTION OF THE INVENTION

In the following, an industrial robot comprising an adapter for optional use to change the manner of mounting the industrial robot to a support structure, and a system comprising such industrial robot, will be described. The same or similar reference numerals will be used to denote the same or similar structural features.

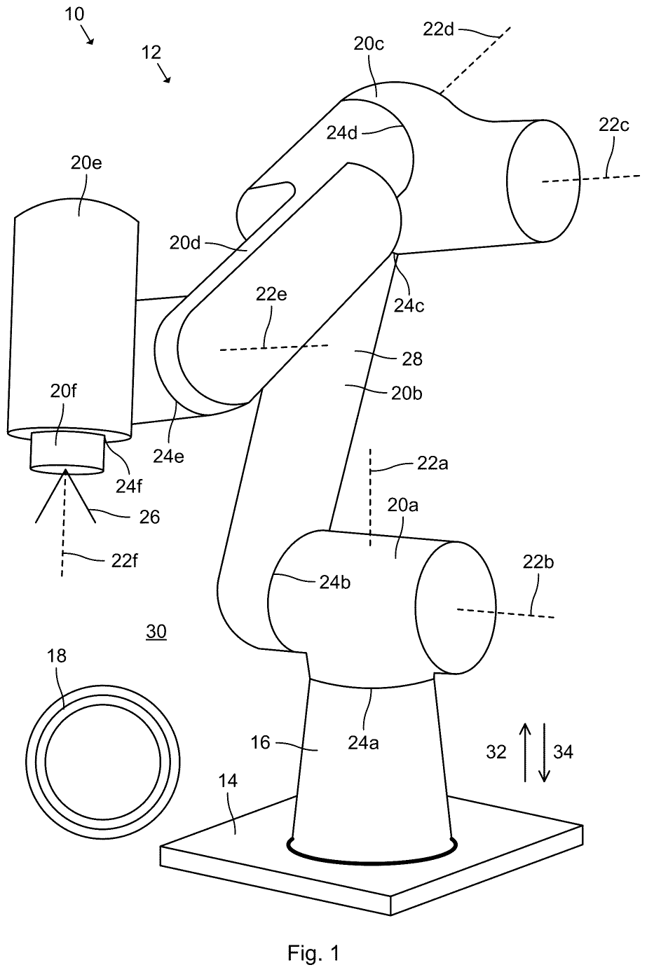

FIG. 1 schematically represents a perspective view of a system 10. The system 10 comprises an industrial robot 12. The system 10 further comprises a support structure 14 for the industrial robot 12. The support structure 14 is here exemplified as a horizontal plate.

The industrial robot 12 of this example is a hygienic robot, e.g., for handling food, beverages and/or pharmaceuticals. The industrial robot 12 of this example meets the IP69K rating according to the German standard DIN 40050-9. The IP rating may however be lower in some implementations.

The industrial robot 12 comprises a base member 16, here exemplified as a substantially cylindrical member. The base member 16 is mounted to the support structure 14. The industrial robot 12 further comprises an adapter 18. The adapter 18 can optionally be used when mounting the industrial robot 12 to the support structure 14 as described herein.

The industrial robot 12 of this specific and non-limiting example further comprises a first link 20a rotatable relative to the base member 16 about a first axis 22a at a first joint 24a, a second link 20b rotatable relative to the first link 20a about a second axis 22b at a second joint 24b, a third link 20c rotatable relative to the second link 20b about a third axis 22c at a third joint 24c, a fourth link 20d rotatable relative to the third link 20c about a fourth axis 22d at a fourth joint 24d, a fifth link 20e rotatable relative to the fourth link 20d about a fifth axis 22e at a fifth joint 24e, and a sixth link 20f rotatable relative to the fifth link 20e about a sixth axis 22f at a sixth joint 24f. The industrial robot 12 of this example is thus a serial six-axis manipulator. Each link 20a-20f may be made of stainless steel. In this example, the industrial robot 12 further comprises an end effector 26, here exemplified as a gripper, connected to the sixth link 20f.

The base member 16 and the links 20a-20f form a housing 28 of the industrial robot 12. The housing 28 here forms a hermetic seal between an exterior region 30 outside the housing 28 and an interior region inside the housing 28. Water and air are prevented from entering into the interior region of the housing 28 and vice versa.

FIG. 1 further shows a first direction 32 and a second direction 34, opposite to the first direction 32. The first direction 32 is here a distal direction of the industrial robot 12.

The second direction 34 is here a proximal direction of the industrial robot 12.

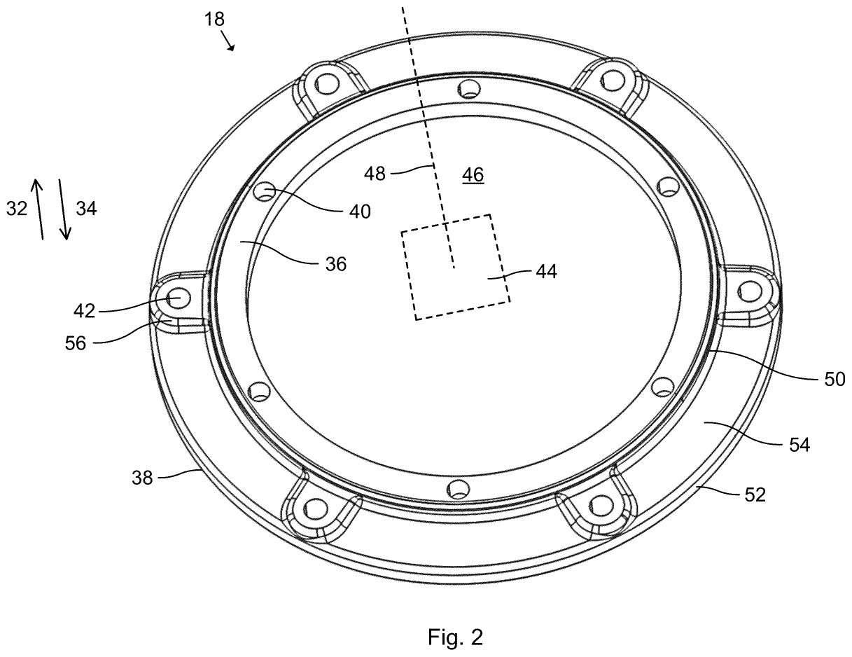

FIG. 2 schematically represents a perspective view of the adapter 18 according to one example. The adapter 18 comprises a first adapter interface 36 and a second adapter interface 38. The first and second adapter interfaces 36 and 38 of this example are flat surfaces facing opposite directions. When the adapter 18 is used to mount the industrial robot 12 to the support structure 14, the first adapter interface 36 faces in the first direction 32 and the second adapter interface 38 faces in the second direction 34. The first and second adapter interfaces 36 and 38 are here exemplified as parallel surfaces.

The adapter 18 further comprises a plurality of first through holes 40 and a plurality of second through holes 42. The first through holes 40 are here provided in the first adapter interface 36. The second through holes 42 are provided in the second adapter interface 38. The number of first through holes 40 may or may not correspond to the number of second through holes 42.

The adapter 18 of this example is flat and has a main extension plane 44. The adapter 18 is hollow and comprises an adapter opening 46 aligned with the main extension plane 44. The adapter opening 46 extends through the adapter 18 and is circular in this example.

The adapter 18 has an adapter axis 48. The adapter axis 48 is here concentric with the adapter opening 46 and transverse to the main extension plane 44. The second through holes 42 are positioned radially outside of the first through holes 40 with respect to the adapter axis 48.

The adapter 18 further comprises a first exterior adapter surface 50 and a second exterior adapter surface 52. In this example, each of the first and second exterior adapter surfaces 50 and 52 is a cylindrical surface concentric with the adapter axis 48. Each of the first and second exterior adapter surfaces 50 and 52 thus has a rounded shape extending in a circumferential direction of the adapter 18. The first exterior adapter surface 50 is positioned inside of the second exterior adapter surface 52, here between the adapter axis 48 and the second exterior adapter surface 52. The first exterior adapter surface 50 encloses the first through holes 40. The second exterior adapter surface 52 encloses the second through holes 42. In this example, the first and second through holes 40 and 42 extend in parallel with the first and second exterior adapter surface 50 and 52.

The adapter 18 further comprises a transition surface 54. The transition surface 54 is arranged between the first exterior adapter surface 50 and the second exterior adapter surface 52. The transition surface 54 is a conical surface with respect to the adapter axis 48.

The adapter 18 of this example further comprises a plurality of lugs 56. Each lug 56 accommodates one of the second through holes 42. Each lug 56 rises from the transition surface 54.

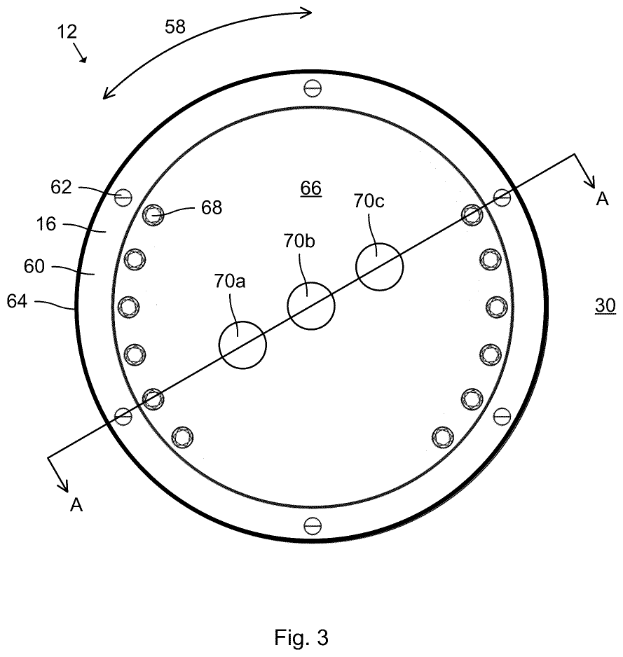

FIG. 3 schematically represents an end view of the industrial robot 12 and the base member 16, as viewed in the first direction 32. In FIG. 3, the adapter 18 is not mounted to the base member 16. FIG. 3 also shows a circumferential direction 58 of the base member 16.

The base member 16 comprises a base interface 60, here exemplified as a flat surface. When the industrial robot 12 is mounted to the support structure 14, the base interface 60 faces in the second direction 34.

The base member 16 further comprises a plurality of base holes 62. In this example, the number of base holes 62 (here six) corresponds to the number of first through holes 40. Each base hole 62 is here exemplified as a blind hole. The base holes 62 are here provided in the base interface 60 and extend transverse to the base interface 60.

The industrial robot 12 of this example comprises a base seal 64. The base seal 64 encloses the base member 16 along its circumferential direction 58. The base seal 64 faces towards the exterior region 30.

The industrial robot 12 of this example further comprises a cover 66, here exemplified as a flat lid. The cover 66 is detachably attachable to the base member 16 by a plurality of bolts 68. As shown, the cover 66 is provided inside of the base holes 62.

The cover 66 comprises a plurality of cover openings, here a first cover opening 70a, a second cover opening 70b and a third cover opening 70c, all exemplified as through holes.

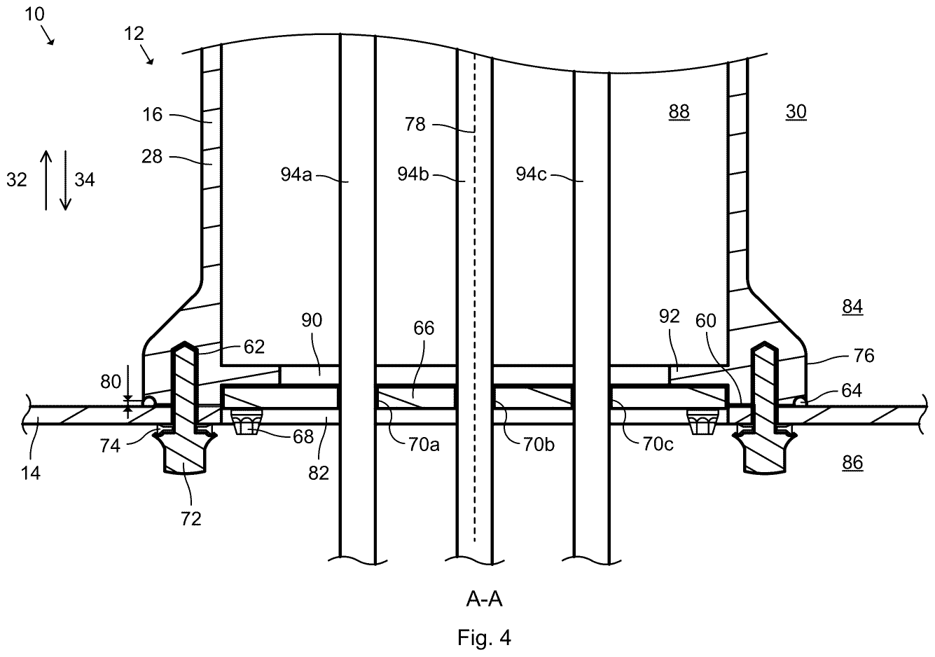

FIG. 4 schematically represents a cross-sectional side view of the base member 16 along line A-A in FIG. 3. In FIG. 4, the industrial robot 12 is mounted bottom up, i.e., in a first manner, to the support structure 14 without the adapter 18. Despite not using the adapter 18 in FIG. 4, the industrial robot 12 is ready to perform one or more tasks, e.g., by moving the end effector 26 in space.

The base interface 60 mates with the support structure 14. The base member 16 is secured to the support structure 14 by a plurality of bolts 72 passing through the support structure 14 in the first direction 32. Each bolt 72 passes through the support structure 14 and threadingly engages one of the base holes 62. A washer 74 is provided for each bolt 72.

The base member 16 of this example comprises an exterior base surface 76. The exterior base surface 76 of this example is cylindrical. The exterior base surface 76 extends in the circumferential direction 58 of the base member 16 and encloses the base holes 62. The exterior base surface 76 thus also extends in a direction parallel with the base holes 62 in this example.

The base member 16 defines a base axis 78. The base member 16 of this example is concentric with the base axis 78. In case the base member 16 does not comprise a circular or substantially circular cross-sectional profile, the base axis 78 may be a main extension axis of the base member 16.

The base seal 64 abuts the exterior base surface 76. The base seal 64 is positioned immediately adjacent to the exterior base surface 76 and bridges a gap 80 between the base member 16 and the support structure 14 to thereby seal the gap 80. A width of the gap 80 in a direction parallel with the base axis 78 may be at least 0.1 mm. In this example, the base seal 64 bulges out with respect to the exterior base surface 76. The base seal 64 may alternatively be flush with the exterior base surface 76.

As shown in FIG. 4, the support structure 14 of this example comprises a support structure opening 82 extending through the support structure 14. The support structure 14 is oriented horizontally in FIG. 4 but may be oriented arbitrarily in space. FIG. 4 further denotes an inside 84 and an outside 86 of the support structure 14. The base member 16 is positioned on the inside 84 of the support structure 14. In examples where the adapter 18 is not used to mount the industrial robot 12, the adapter 18 may for example be accommodated at the outside 86 of the support structure 14 during operation of the industrial robot 12.

In FIG. 4, the interior region 88 inside the housing 28 of the industrial robot 12 can be seen. The base member 16 is hollow to partly define the interior region 88 therein. The base member 16 further comprises a base opening 90. The base opening 90 opens into the interior region 88. When the cover 66 is removed, the base opening 90 opens also to the outside 86.

The base member 16 of this example further comprises a flange 92. The flange 92 protrudes inwards towards the base axis 78. The bolts 68 threadingly engage the base member 16, here the flange 92 thereof, to secure the cover 66 to the base member 16. By loosening the bolts 68, the cover 66 can be moved through the support structure opening 82 and to the outside 86.

The industrial robot 12 of this example further comprises a plurality of lines, here exemplified as a power and signal line 94a, an air input line 94b and an air output line 94c.

The power and signal line 94a provides electric power and/or signals from an electric source (not shown) at the outside 86 of the support structure 14, through the cover 66, here the first cover opening 70a thereof, through the base opening 90 and to various electric components in the interior region 88, such as electric motors of the joints 24a-24f and/or the end effector 26. The air input line 94b provides a supply of air from a pressure source (not shown), through the cover 66, here the second cover opening 70b thereof, through the base opening 90 and into the interior region 88. The air may be used to cool and/or heat components in the interior region 88. Alternatively, or in addition, the air may be used to provide ventilation of the interior region 88. Alternatively, or in addition, the air may be used to establish an overpressure (with respect to the exterior region 30) in the interior region 88. In any case, air in the interior region 88 is led out to the outside 86 through the base opening 90, through the cover 66, here the third cover opening 70c thereof, by the air output line 94c. According to examples, the only communication of air between the interior region 88 and the outside 86 is through the cover 66.

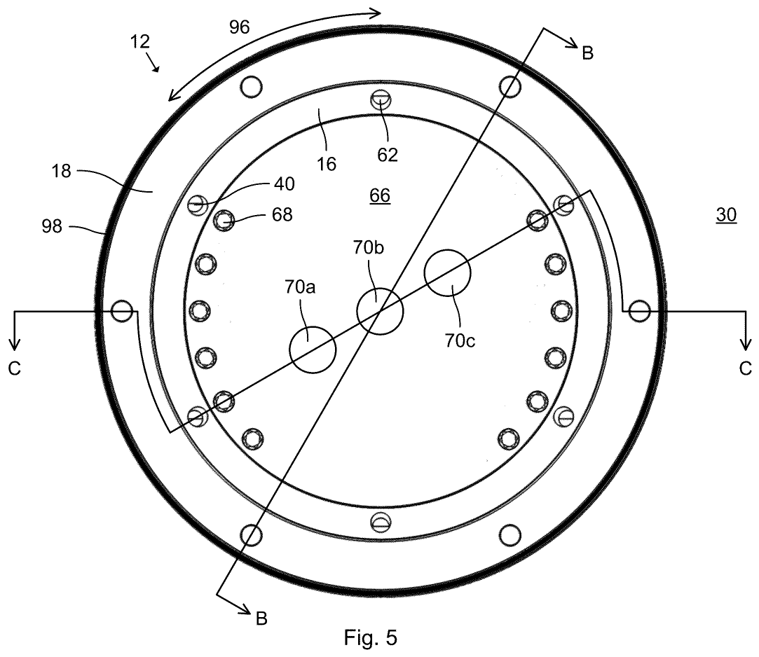

FIG. 5 schematically represents an end view of the industrial robot 12, the base member 16 and the adapter 18, as viewed in the first direction 32. In FIG. 5, the adapter 18 is mounted to the base member 16. FIG. 5 further shows the circumferential direction 96 of the adapter 18.

The adapter 18 of this example comprises an adapter seal 98. The adapter seal 98 encloses the adapter 18 along its circumferential direction 96. The adapter seal 98 faces towards the exterior region 30.

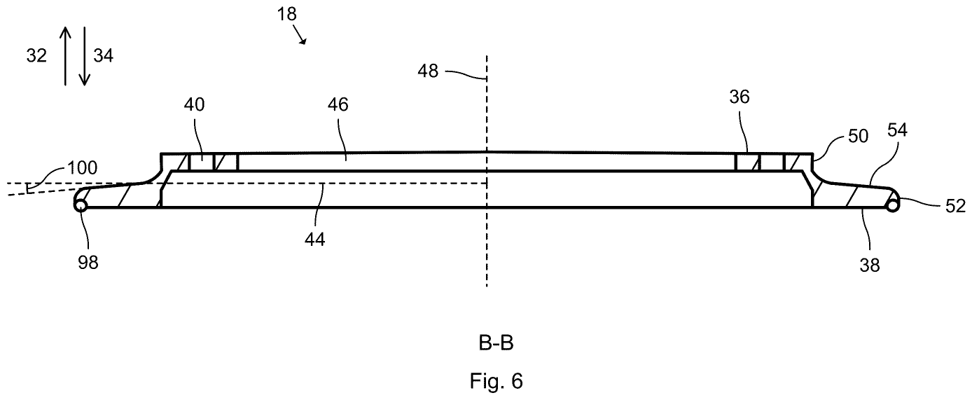

FIG. 6 schematically represents a cross-sectional side view of the adapter 18 along line B-B in FIG. 5. As shown, the transition surface 54 is inclined away from the adapter axis 48 such that an angle 100 between the main extension plane 44 and the transition surface 54 is at least three degrees, here five degrees. This improves the hygienic design of the adapter 18.

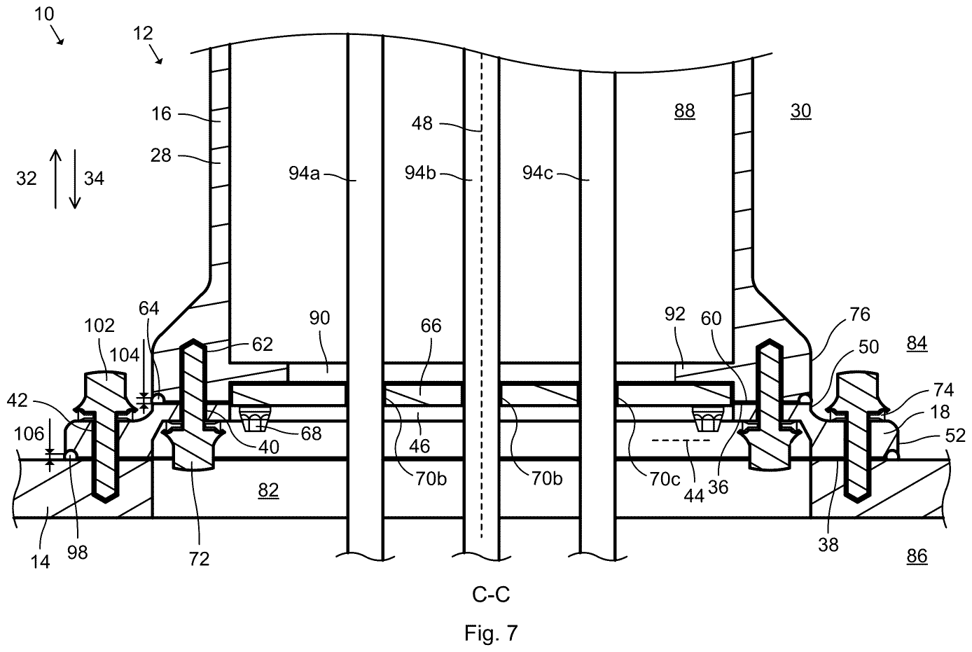

FIG. 7 schematically represents a cross-sectional side view of the base member 16 and the adapter 18 along line C-C in FIG. 5. In FIG. 7, the industrial robot 12 is mounted top down, i.e., in a second manner, to the support structure 14 by using the adapter 18. When the adapter 18 is used to mount the industrial robot 12 to the support structure 14, the base interface 60 mates with the first adapter interface 36 and the second adapter interface 38 mates with the support structure 14. The base interface 60, the first adapter interface 36 and the second adapter interface 38 are here parallel.

In FIG. 7, the industrial robot 12 is ready to perform one or more tasks, e.g., by moving the end effector 26 in space. As shown, the first through holes 40 here extend transverse to the first adapter interface 36 and the second through holes 42 here extend transverse to the second adapter interface 38.

Instead of securing the base member 16 directly to the support structure 14, the bolts 72 are now used to secure the adapter 18 to the base member 16. Each bolt 72 now passes through one of the first through holes 40 in the first direction 32 and threadingly engages one of the base holes 62. The first through holes 40 and the base holes 62 are thus aligned when the adapter 18 is secured to the base member 16.

The adapter 18 is in turn secured to the support structure 14 by a plurality of bolts 102. Each bolt 102 passes through one of the second through holes 42 in the second direction 34 and threadingly engages the support structure 14. The bolts 102 may alternatively threadingly engage a nut (not shown) on the outside 86. A washer 74 is provided for each bolt 102.

The base seal 64 now bridges a gap 104 between the base member 16 and the adapter 18 to thereby seal the gap 104. The exterior base surface 76 is flush with the first exterior adapter surface 50 with the base seal 64 positioned therebetween. Thus, in this example, the exterior base surface 76 and the first exterior adapter surface 50 have the same diameter.

The adapter seal 98 abuts the second exterior adapter surface 52. The adapter seal 98 is positioned immediately adjacent to the second exterior adapter surface 52 and bridges a gap 106 between the adapter 18 and the support structure 14 to thereby seal the gap 106. In this example, the base seal 64 bulges out with respect to the exterior base surface 76 and the adapter seal 98 bulges out with respect to the second exterior adapter surface 52. A width of each of the gaps 104 and 106 in a direction parallel with the adapter axis 48 may be at least 0.1 mm.

By loosening the bolts 68, the cover 66 can be moved through the adapter opening 46, through the support structure opening 82 and to the outside 86.

Both the base member 16 and the adapter 18 are designed with smooth exterior profiles. For both the base member 16 and the adapter 18, all exterior transitions between surfaces may have a minimum radius of 3 mm. The base member 16 and the adapter 18 are made of stainless steel in this example. The surface roughness Ra of all exterior surfaces of the base member 16 and the adapter 18 may be 0.8 μm or less measured according to ISO 4287:1997.

Due to the angle 100 of the transition surface 54, the adapter 18 is self-draining even if the base member 16 stands vertically upwards from the support structure 14. The transition surface 54 directs any liquid away from the base member 16.

The adapter 18 as described herein thus enables a selective top down mounting of the industrial robot 12 without having to provide a dedicated design of the base member 16 to this end and without compromising the hygienic design of the industrial robot 12.

In the context of the present disclosure, optional use of the adapter means that the industrial robot is configured to operate both with and without the adapter when mounted to the support structure. Since the industrial robot comprises the adapter for optional use, the industrial robot can be mounted either bottom up or top down to the support structure without having to provide two different designs of the base member. When the industrial robot is mounted without the adapter, the industrial robot can be mounted bottom up to the support structure. Conversely, when the industrial robot is mounted with the adapter, the industrial robot can be mounted top down to the support structure. The industrial robot therefore provides an improved flexibility of mounting to the support structure.

The industrial robot may be a hygienic industrial robot. To this end, the industrial robot may meet the IEC (International Electrotechnical Commission) standard 60529 and/or the IP69K rating according to the German standard DIN 40050-9. The base member may be a foot of the industrial robot. The adapter may be referred to as a foot addon for the industrial robot. The support structure may be or comprise a plate, such as a substantially flat, or flat, plate. The support structure may be oriented arbitrarily in space, including horizontally and vertically oriented. The support structure may for example be a floor, a wall or a ceiling.

Each of the base member and the adapter may be made of metal, such as stainless steel. Also the support structure may be made of metal, such as stainless steel.

The base interface may be parallel with the support structure when the industrial robot is mounted thereto, both with and without the adapter. The first adapter interface may be parallel with the second adapter interface.

Each base hole may be a blind hole or a through hole. Each base hole may extend substantially transverse to, or transverse to, the base interface. The first through holes may be provided in the first adapter interface. The first through holes may extend substantially transverse to, or transverse to, the first adapter interface.

The second through holes may be provided in the second adapter interface. The second through holes may extend substantially transverse to, or transverse to, the second adapter interface. The second through holes may be positioned outside of the first through holes.

The base member may comprise an exterior base surface enclosing the base holes and include a rounded shape extending in a circumferential direction thereof, e.g., around a central base axis of the base member. In these cases, the adapter may comprise a second exterior adapter surface enclosing the second through holes and include a rounded shape extending in a circumferential direction thereof, e.g., around a central adapter axis of the adapter. The rounded shape of the base surface may be substantially parallel with, or parallel with, the base holes. The rounded shape of the second exterior adapter surface may be substantially parallel with, or parallel with, the second through holes. Examples of rounded shapes include circular shapes and oval shapes.

The industrial robot may further comprise an exterior base seal enclosing the base member and arranged to bridge a gap between base member and the adapter when the first adapter interface mates with the base interface, and arranged to bridge a gap between the base member and the support structure when the base interface mates with the support structure.

With the base seal being exterior is meant that the base seal faces outwards, i.e., towards an exterior region of the industrial robot. The base seal thus prevents any direct external contact between the base member and the adapter when the adapter is used, and between the base member and the support structure when the adapter is not used and therefore reduces a growth risk of bacteria in these areas.

The base seal may abut the exterior base surface. The base seal may thus be positioned immediately adjacent to the exterior base surface. The adapter may comprise an exterior adapter seal enclosing the adapter and arranged to bridge a gap between the adapter and the support structure when the second adapter interface mates with the support structure. Similarly to the base seal, with the adapter seal being exterior is meant that the adapter seal faces outwards, i.e., towards an exterior region of the industrial robot. The adapter seal thus prevents any direct external contact between the base member and the adapter when the adapter is used and therefore reduces a growth risk of bacteria in this area.

The adapter seal may abut the second exterior adapter surface. The adapter seal may thus be positioned immediately adjacent to the second exterior adapter surface.

The first through holes may be aligned with the base holes when the adapter is secured to the base member such that a single bolt can be received in both a first through hole and a base hole. The adapter may comprise a first exterior adapter surface. In these cases, the exterior base surface may be flush with the first exterior adapter surface when the base interface mates with the first adapter interface. The first exterior adapter surface may include a rounded shape extending in a circumferential direction thereof. The rounded shape of the first exterior adapter surface may be substantially parallel with, or parallel with, the first through holes.

The adapter may be hollow by comprising an adapter opening. The adapter opening may have a main extension in a direction transverse to a central adapter axis of the adapter.

The base member may comprise a base opening. In these cases, the industrial robot may further comprise a cover detachably attachable to the base member inside of the base holes to close the base opening. The cover may be a lid. The cover may be directly attached to the base member, i.e., to contact the base member.

The cover may be movable through the adapter opening when the adapter is secured to the base member.

The industrial robot may comprise a line passing through the cover and into an interior region inside the base member. The industrial robot may comprise only one line or a plurality of lines. Examples of such lines comprise a power cable, a signal cable, a sensor cable, a power and signal cable, an air input line and an air output line. The cover may comprise one or more cover openings and one or more lines may pass through each cover opening.

The adapter may comprise a transition surface between the first exterior adapter surface and the second exterior adapter surface and a main extension plane. In these cases, the transition surface may be inclined away from an adapter axis of the adapter such that an angle between the main extension plane and the transition surface is at least three degrees.

According to a second aspect, there is provided a system comprising the industrial robot according to the first aspect, and the support structure. The support structure may be of any type as described in connection with the first aspect, and vice versa. The support structure may comprise a support structure opening. The cover may be movable through the support structure opening when the base member is secured to the support structure, with or without the adapter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. An industrial robot, comprising:
a base member including a base interface and a plurality of base holes for receiving bolts passing through a support structure in a first direction to secure the base member to the support structure such that the base interface mates with the support structure;
wherein the industrial robot further comprises an adapter adapted to change a manner of mounting the industrial robot to the support structure, the adapter including a first adapter interface, a second adapter interface, a plurality of first through holes for receiving bolts to secure the adapter to the base member such that the first adapter interface mates with the base interface, and a plurality of second through holes for receiving bolts passing therethrough and into the support structure in a second direction, opposite to the first direction, to secure the adapter to the support structure such that the second adapter interface mates with the support structure.

2. The industrial robot according to claim 1, wherein the base member comprises an exterior base surface enclosing the base holes and including a rounded shape extending in a circumferential direction thereof, and wherein the adapter comprises a second exterior adapter surface enclosing the second through holes and including a rounded shape extending in a circumferential direction thereof.

3. The industrial robot according to claim1, further comprising an exterior base seal enclosing the base member and arranged to bridge a gap between base member and the adapter when the first adapter interface mates with the base interface, and arranged to bridge a gap between the base member and the support structure when the base interface mates with the support structure.

4. The industrial robot according to claim 3, wherein the base seal abuts the exterior base surface.

5. The industrial robot according to claim 1, wherein the adapter comprises an exterior adapter seal enclosing the adapter and arranged to bridge a gap between the adapter and the support structure when the second adapter interface mates with the support structure.

6. The industrial robot according to claim 3, wherein the adapter seal abuts the second exterior adapter surface.

7. The industrial robot according to claim 1, wherein the first through holes are aligned with the base holes when the adapter is secured to the base member such that a single bolt can be received in both a first through hole and a base hole.

8. The industrial robot according to claim 2, wherein the adapter comprises a first exterior adapter surface, and wherein the exterior base surface is flush with the first exterior adapter surface when the base interface mates with the first adapter interface.

9. The industrial robot according to claim 1, wherein the adapter is hollow and includes an adapter opening.

10. The industrial robot according to claim 9, wherein the base member comprises a base opening, and wherein the industrial robot further comprises a cover detachably attachable to the base member inside of the base holes to close the base opening.

11. The industrial robot according to claim 10, wherein the cover is movable through the adapter opening when the adapter is secured to the base member.

12. The industrial robot according to claim 11, wherein the industrial robot comprises a line passing through the cover and into an interior region inside the base member.

13. The industrial robot according to claim 8, wherein the adapter comprises a transition surface between the first exterior adapter surface and the second exterior adapter surface, and wherein the transition surface is inclined away from an adapter axis of the adapter such that an angle between a main extension plane and the transition surface is at least three degrees.

14. The industrial robot according to claim 1, further comprising the support structure.
